(19) United States
(12) Patent Application Publication
(10) Pub. No.: US 2002/0074347 A1
(43) Pub. Date: Jun. 20, 2002

(54) Multi-compartment container and dispensing device

(75) Inventors: Charles Douglas Murray, Strombeek-Bever (BE); Riccardo Calvi, Roma (IT); Jean-Luc Azzani, Rome (IT); Lyle Brown Tuthill, Waterloo (BE); Filip Dominique Hubert Vangeel, Vilvoorde (BE)

Correspondence Address: THE PROCTER & GAMBLE COMPANY, PATENT DIVISION, IVORYDALE TECHNICAL CENTER - BOX 474, 5299 SPRING GROVE AVENUE, CINCINNATI, OH, 45217, US

(73) Assignee: The Procter & Gamble Company

(21) Appl. No.: 09/949,950

(22) Filed: Sep. 10, 2001

Related U.S. Application Data
(60) Provisional application No. 60/278,124, filed on Mar. 23, 2001.
(60) Provisional application No. 60/244,307, filed on Oct. 30, 2000.
(60) Provisional application No. 60/233,038, filed on Sep. 15, 2000.

(51) Int. Cl. B67D 5/56

(52) U.S. Cl. 222/129

(57) ABSTRACT

Multi-compartment container having a septum extending from the bottom of the container up through the neck to the container opening. A closure seals the container from leakage and prevents internal contamination between compartments. The container may be blow molded in a single manufacturing step.

### CROSS-REFERENCE TO RELATED APPLICATION

This patent application claims the benefit of U.S. Provisional Application Ser. No. 60/278,124 filed Mar. 23, 2001 by Murray et al., U.S. Provisional Application Ser. No. 60/244,307 filed Oct. 30, 2000 by Tuthill et al., and U.S. Provisional Application Ser. No. 60/233,838 filed Sep. 15, 2000 by Calvi et al.

### BACKGROUND OF THE INVENTION

1. Field of the Invention

The present invention relates to multi-compartment containers for containing and dispensing flowable compositions. More specifically, the present invention relates to dual compartment containers that dispense flowable compositions in a 1:1 ratio under the influence of gravity. Examples of such containers are the plastic containers that are commonly used for packaging solid and liquid detergents, cleaners and foodstuffs. This invention also pertains to methods for manufacturing a dual chambered container that is lightweight, strong and inexpensive to produce.

2. Description of the Prior Art

Plastic containers are in wide use throughout the United States and the world for packaging virtually every type of liquid and solid material, for both commercial and household applications. The detergent industry, for example, has turned increasingly to plastic containers for packaging such products as bleach, soap, sanitizing agents, and polishes. Plastic is relatively inexpensive, will not shatter when dropped, and is recyclable.

Some products are best packaged, for reasons of both marketability and convenience, together with one or more other products in a container that has more than one chamber, or in a pair of containers that are joined together in some manner. With respect to the latter mentioned option, packaging is known that includes two separate containers that are joined together by a common closure having two openings. U.S. Pat. Nos. 5,289,950 and 5,252,312 disclose packaging of this type. This type of combined container is relatively expensive to make because of the complexity of the manufacturing process and the relatively large amount of plastic material per volume of product that is being packaged. Further, such combined containers are undesirable to the extent that the design leaves open the possibility of separation of the individual containers during use. Other known processes for producing a plastic container having more than one chamber include those where a container is first molded as a single chambered container, and then heat sealed into separate compartments in a subsequent reforming step. Because of this second reforming and heating step, the manufacturing process is more time consuming and expensive. In addition, because the compartments that are attached by the heat sealing step tend to be joined together only by a thin web of material, the resulting product tends to be overly flexible and requires reinforcement by and external device such as a special closure, a base cup or an adhesive label that is positioned to prevent relative movement between the formed compartments.

A process using an injection, extrusion blow molding method is disclosed in U.S. Pat. No. 5,882,574, assigned to Owens-Brockway Plastic Products, Inc. However, this hybrid process also requires a time consuming manufacturing step wherein a neck ring is injection molded before blow molding of the rest of the container body. A need still exists for an improved multi-chambered container that is lightweight, robust and relatively inexpensive to produce with fewer manufacturing steps. Solid neck finish requires additional materials-requires longer to cool.

### SUMMARY OF THE INVENTION

The present invention provides a multi-compartment container for containing two or more different flowable compositions. This container includes a base, a neck having an opening for dispensing the compositions, a sidewall that interconnects the base and neck and defines an internal chamber for the compositions. A septum extends downwardly from the opening and divides the chamber into two or more compartments. Preferably, the septum forms a pair of channels in the external surface of the sidewall that run the length of the container from the base through the neck. Even more preferably, each of the channels is narrowed by a pair of opposed projections within the channels in the region where the neck connects to the sidewall.

The present invention further provides a dual compartment container having means for dispensing flowable compositions from the compartments under the influence of gravity in substantially a 1:1 ratio. Such dispensing means can be a restriction located in the neck opening that regulates the size and/or shape of the opening.

In addition, such dispensing means include for orienting the container during dispensing so that the septum between the compartments is maintained in substantially a vertical orientation during dispensing. Such orientation means can comprise depressions in the sidewall that have a long axis that is parallel to the septum. In addition, the orientation means may comprise a handle attached to the sidewall in a plane that is parallel to the septum. Optionally, such a handle may be pivotably attached to the sidewall to enable the container to pivot relative to the handle during dispensing. Further suitable orientation means are flip-top closures and/or features on the container that mate or nest with complementary features on the dispensing cup as mentioned below.

The present invention also provides improved accuracy in the dispensing of flowable compositions from a dual compartment bottle under the influence of gravity by providing a bottle shape that reduces the tendency of the consumer to rotate the bottle during dispensing and/or reduce the disruption of the flowing compositions when such rotation occurs.

The present invention further still provides a dispensing device for receiving compositions poured from a dual compartment container, the dispensing device and container having mating features that promote proportionate dispensing of the compositions from the container.

In a process aspect of the present invention, a method for blow molding a dual compartment container in a single step is provided wherein a parison is placed in the mold so that the entire container, including the base, sidewall, neck, and septum are blow molded in a single step. When present, the mold may be modified to provide a handle along with the rest of the mold. In the alternative, a pre-formed handle may be attached subsequent to the molding of the container.

### BRIEF DESCRIPTION OF THE DRAWINGS

FIG. 1a is a frontal view of a container of the present invention.

FIG. 1b is a side view of the container in FIG. 1a.

FIG. 1c is a cross sectional view of the container in FIG. 1a along line C-C'.

FIG. 2a is a perspective view of a container of the present invention having a handle.

FIG. 2b is elevated perspective view of the container in FIG. 2a.

FIG. 2c is an elevated view of the container in FIG. 2a showing the septum dividing the container into dual compartments.

FIG. 2d is view of the bottom of the container in FIG. 2a.

FIG. 3a is a cross sectional view of a blow pin that may be used to prepare the dual compartment container of the present invention.

FIG. 3b is a side view of an upper portion of the dual compartment container of the present invention.

FIG. 4a is an over view of a dispensing cup that may be used in conjunction with a multi-compartment container of the present invention.

FIG. 4b, is a side view of the dispensing cup in FIG. 4a.

FIG. 5a is a perspective view of a dual compartment container of the present invention with a dispensing device for mating with said container.

FIG. 5b is a side view of the container and dispensing device of FIG. 5a.

FIG. 6a is a perspective view of a dual compartment container of the present invention with a dispensing device for mating with said container.

FIG. 6b is a side view of the container and dispensing device of FIG. 6a.

FIG. 7a is a perspective view of a dual compartment container of the present invention with a dispensing device for mating with said container.

FIG. 7b is a side view of the container and dispensing device of FIG. 7a.

FIG. 8a is a perspective view of a dual compartment container of the present invention with a dispensing device for mating with said container.

FIG. 8b is a side view of the container and dispensing device of FIG. 8a.

FIG. 9a is a side view of a dual compartment container of the present invention with a flip-top cap.

FIG. 9b is a perspective view of the container of FIG. 9a.

### DETAILED DESCRIPTION OF THE PREFERRED EMBODIMENT

The container of the present invention can have multiple compartments, but is described herein as a dual compartment container. A preferred form is a free-standing container having an opening at the top of a neck for pouring or dispensing the compositions from the container under the influence of gravity. The container is especially suitable for dispensing a plurality of doses of a two-part or multi-part liquid or other flowable composition.

The containers of the present invention have relatively rigid walls made from any plastic material that is compatible with extrusion blowing. Such materials will include PE, PP, PVC, and PET among others as well as post-consumer recycled materials. Likewise the materials may be processed in single or multiple layers. Because a variety of different materials may be used in the construction of the containers of the present invention the materials selected will be based on the intended end use and characteristics required of such a container.

The dimensions of the container will also vary depending on end-use, and the size and shape of the container may be easily modified through alterations to the mold to accommodate different dimensions and features. The total volume of the containers of the present invention may range from 100 ml to 25 L or more. Likewise, the relative dimensions of the compartments within the container may vary as well. For example, in a dual-compartment execution, although two equal dimensioned compartments may be used, embodiments in which the compartments have different dimensions are also contemplated. More specifically, for a laundry application wherein the container may hold detergent, bleach, fabric softener and/or other fabric care compositions, it is desirable for the container to have sufficient volume to permit storage of from at least about 5 doses to about 50 doses of each composition. Typical dosage volumes for such laundry compositions are from about 10 ml to about 300 ml for the total of volumes coming from the sum of all compartments.

The cross sectional shape of the container can have a significant impact on the ability of a consumer to accurately dispense compositions from the dual compartments in a 1:1 ratio. Certain shapes have been determined to provide more consistent dispensing. “Consistently accurate dispensing” may be determined by dispensing compositions from the dual compartment container in individual doses and for each dose determining the ratio of the compositions from the separate chambers. The standard deviation is then calculated for the sampling for each container shape, or as discussed below for each location of the container spout. Deviations of greater than about 0.25 are considered to provide inconsistent or inaccurate dispensing. Deviations of less than about 0.25 are considered to provide consistent, accurate dispensing.

Not to be bound by theory, but it is believed that certain cross sectional shapes reduce the user's tendency to rotate the container during the pour. Generally, the shapes that provided more consistent, accurate dispensing include those shapes that have rounded smooth surfaces such as ovals, ellipses and rounded pyramids. Surprisingly however, containers having circular cross sections do not provide consistent, accurate dispensing. Container shapes that have straight sidewalls such a rectangles, triangles and diamonds also do not provide consistent, accurate dispensing.

It has also been found that the location of the spout or container opening is also critical to providing consistent, accurate dispensing from the container of the present invention. Specifically, spouts located at or near the center of the container top do not provide consistent, accurate dispensing. Containers having the spout off center, and preferably near a sidewall, provide more consistent, accurate dispensing. Most preferably, the spout will be located adjacent the apex or intersection of two portions of the sidewall.

The containers of the present invention can be of the types that have a screw, pull, or snap cap at the top of either a vented or a non-vented design, which can be easily opened by the consumer to permit top-pouring from the compartments. Preferably, the closure is a standard lined closure that will seal not only with the upper surface of the neck, but with the upper surface of the septum as well so that a seal is provided that prevents leakage from the container as well as contamination due to leakage from one compartment to another. Contamination is of utmost concern, as it is anticipated that the contents of the various compartments may be incompatible or tend to degrade or react with one another. Any leakage from one compartment to another should be prevented. Further, unless a mixing compartment or chamber is integrated into such a container, the flowable compositions should not come into contact with one another until they are dispensed from the bottle.

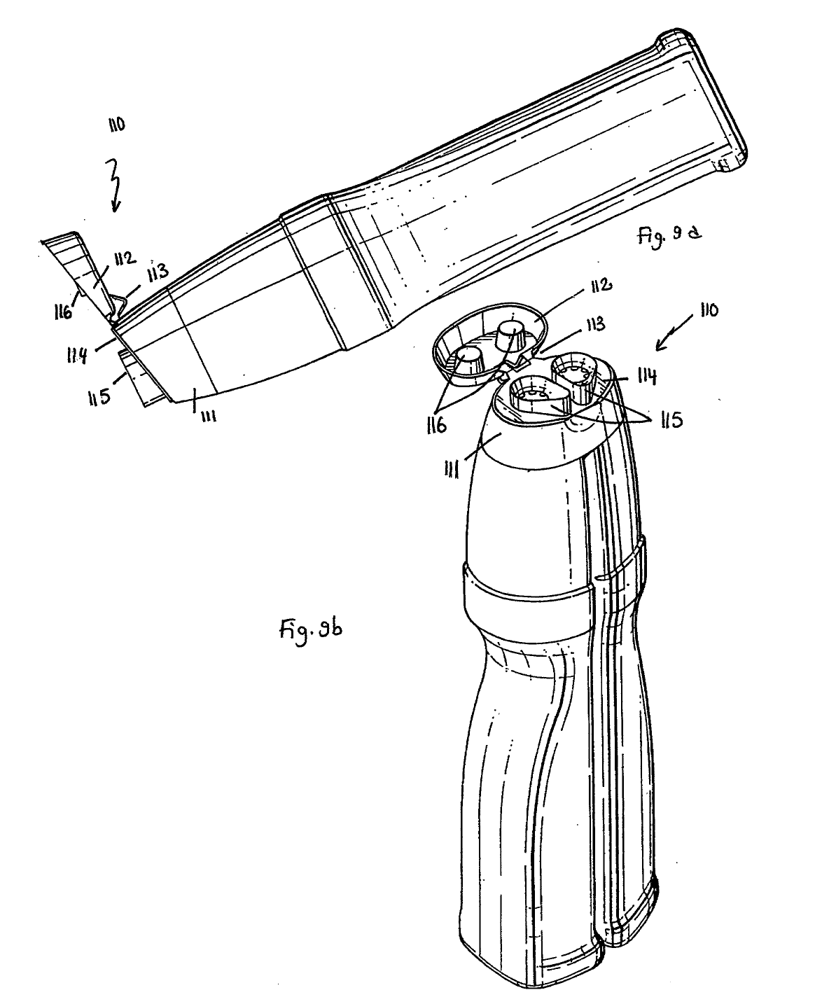

It has been found that flip top closures can also provide consistent and accurate dispensing. A preferred container is illustrated in the appended FIGS. 9a and 9b. Indeed, a suitable means for orienting the container can be a flip-top closure 110 comprising a cap pivoting around a hinge axis which is perpendicular to the container septum plane (See FIG. 9a). By holding the bottle in this manner, the user is most likely to maintain septum 24 in a vertical orientation as the bottle is tilted to dispense its contents. The closure 110 comprises of a skirt 111, a cap 112 associated by a hinge system 113 to the skirt and a platform 114 with at least 2 product exit apertures 115 corresponding to each chamber of the container. The entire closure can be threaded down or can be snapped over the container neck. Each product exit apertures fit inside each openings of the container, preferably by means of plug seal. The cap comprises at least 2 plug seals 116 to prevent leakage from each product exit apertures and from one product exit aperture to the other. The product exit apertures can be shaped to allow intimate mixing at a certain distance from the container thereby avoiding contamination from one compartment to the other during pouring. Further flip top closures are described in WO98/29320, EP 884 249 and WO94/07748.

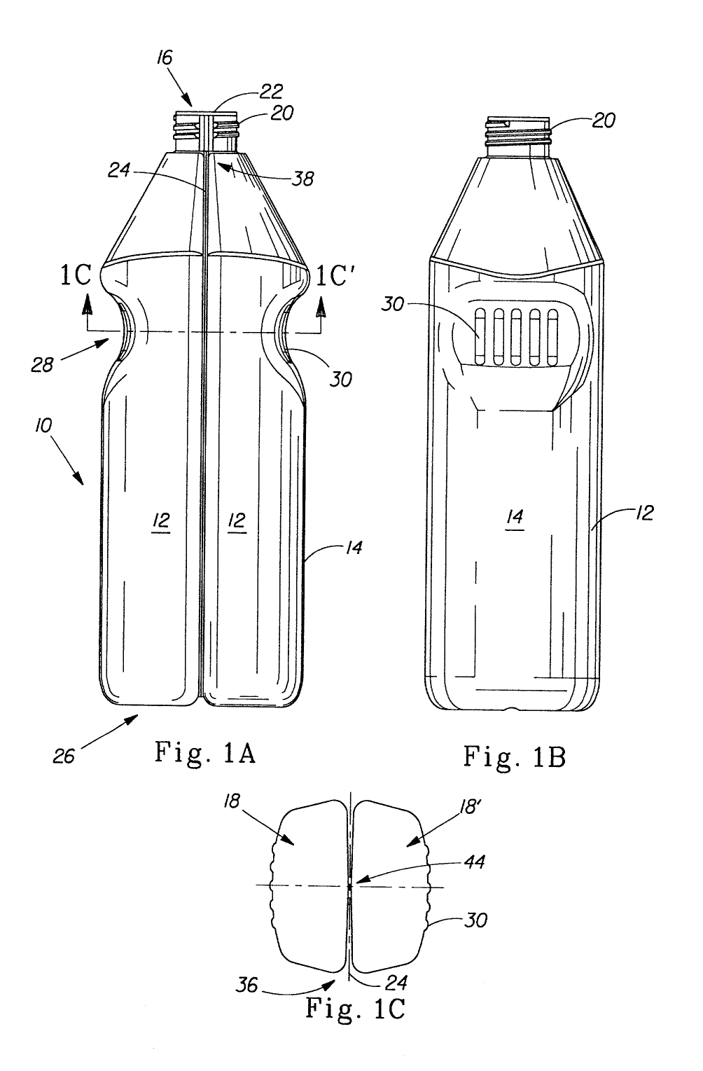

A preferred container is illustrated in the appended FIGS. 1a through 1c. Specifically, FIG. 1a shows dual compartment bottle 10 that is free standing and has base 26 and neck 20. Opening 16 is provided for dispensing flowable compositions from the bottle simply by tilting the bottle and allowing the contents to pour therefrom under the influence of gravity. Bottle 10 has a sidewall interconnecting the base and neck that comprises side surfaces 14, and front and rear surfaces 12. Front and rear surfaces 12 are each divided by a channel 36 which runs the length of the bottle from the base to the top of the neck. Side surfaces 14 are provided with recessed portions 28 to facilitate gripping bottle. Recessed portions 28 have ribs 30 or similar protuberances to enable the consumer to maintain a firm grip on the bottle during dispensing or transport. Further, recessed portions 28 are intended to lead the consumer to hold the bottle at a specific location during dispensing in order to promote 1:1 dispensing as described in more detail below. FIG. 1b provides a side view of bottle 10 to illustrate the arrangement of ribs 30 within recess portion 28.

Opening 16 provides a separate opening for each compartment 18. Upper surface 32 of the septum and upper surfaces 22 around the circumference of opening 16 are preferably uniform and in the same plane so that they will engage with the internal surfaces of a threaded cap, or a liner within such a cap (not shown). Threads 20 are provided on the external surface of neck 20 to engage with such a closure and seal the closure to surfaces 22 and 32.

FIG. 1c shows a cross sectional view of the bottle 10 along line C-C' of FIG. 1a to illustrate the convex surface within recessed portions 28 and the arrangement of ribs 30 along that surface. FIG. 1c also details the internal shape of compartments 18 as defined by septum 24 and the internal surfaces of the sidewall. It is to be noted that septum 24 is not a single wall between the compartments, but is a pair of closely aligned walls that are joined together along seam 44, central to bottle 10. Because the septum walls are joined along central seam 44, channels 36 are provided in the front and rear surfaces. Although the septum walls 24 are not joined across their full width and are not parallel, these walls are generally in the same plane and reference is made below to plane 40, as the plane of septum 24.

The extension of channel 36 through neck 20 creates a neck with two halves. To prevent collapse and leakage from the neck when a closure is tightly threaded down thereupon, channel 36 is narrowed at the base of the neck, referenced as 38 in FIG. 1a. In the event a closure is tighten down on neck 10 causing channel 36 to collapse, the walls at 38 will abut against one another to prevent further collapse or leakage.

To promote uniform dispensing from the compartments it is preferable to maintain plane 40 in a substantially vertical orientation. By maintaining plane 40 in a substantially vertical orientation, compartments 18 are in a side by side relationship and their contents are subjected to substantially the same forces during dispensing. Further, by dispensing in a side-by-side relationship, the potential for contamination between the compartments is reduced relative to dispensing with the compartments in an over and under relationship. Where the orifice to each compartment within opening 16 is of the same size and shape, and provided that the contents of the compartments have generally the same viscosities, the container of the present invention can consistently provide 1:1 dispensing.

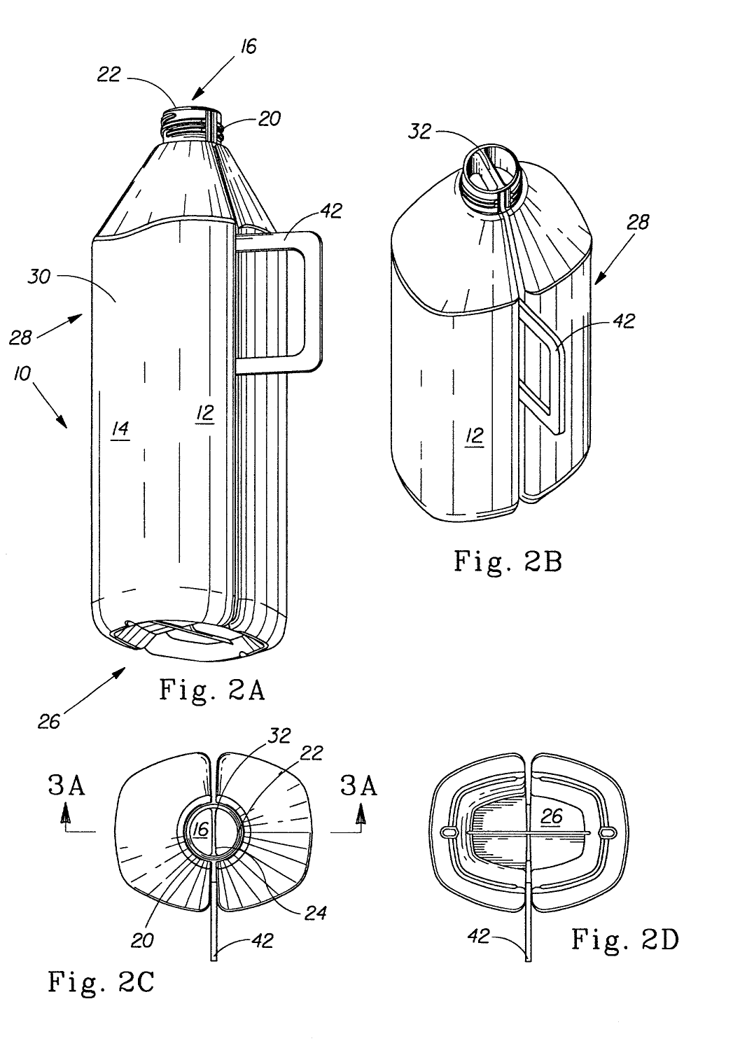

To improve the uniformity of this dispensing, the containers of the present invention also have means to promote uniform dispensing. These means may take a variety of forms and will include the use of restrictors or regulators (not shown) of various sizes and shapes in opening 16 to restrict the flow compositions from the compartments. Unexpectedly, a circular orifice for each of the compartments is not the optimum shape to promote uniform dispensing as ovals and various polygonal shapes have been found to provide more uniform dispensing. In addition, to ensure that the consumer maintains plane 40 in a substantially vertical orientation during dispensing, orientation means may be provided. Specifically, recessions 28 are provide in sidewalls 14 along lines that are generally parallel to plane 40 so that as a consumer grips the bottle and rotates the wrist to tilt the bottle, plane 40 is maintained in a vertical orientation. Likewise, as is illustrated in FIGS. 2a-2d, handle 42 may be included to promote proper orientation of the bottle during dispensing.

FIG. 2a provides a perspective view of bottle 10 providing additional detail concerning bottom 26 and handle 42. FIGS. 2b and 2c are elevated views of bottle 10 and provide additional detail concerning septum 24 and its upper surface 32.

As best illustrated in FIG. 2b, the septum divides bottle 10 into dual compartments 18. Septum 24 and is continuous from the internal surface of base 26 terminating at upper surface 32 at opening 16. Further, upper surface 32 engages with a threaded cap so that the compositions with in bottle 10 do not inadvertently mix during transport or storage. It is intended with bottle 10 that the contents of compartments 18 do not mix within the bottle but are only combined after they have been dispensed. It has also been found that by extending septum 24 up to a level equal with surfaces 22, septum 24 provides additional strength to the bottle in the region of opening 16.

The recessed portions 28 are arranged on side surfaces 14 so that the bottle user grips the bottle at recessed portions 28. By holding the bottle in this manner, the user is most likely to maintain septum 24 in a vertical orientation as the bottle is tilted to dispense its contents. When a container does not have specific means for regulating the flow of composition from each of the compartments, it is preferred that the container have means such as recessed portions 28 for orienting the container so that relatively equal amounts of the different compositions contained in the bottle are dispensed. In addition, orientation means may include handle 42 affixed to the sidewall of the container within channel 36 so that handle 42 is substantially parallel to plane 40. Optionally, handle 42 may be pivotably affixed to the sidewalls of the container so that if handle 42 is not held in a vertical orientation when tilting the container, the container will pivot under the influence of gravity to correct the angle and maintain plane 40 in a vertical orientation during the pour. It is anticipated that when handle 42 is pivotable attached, it may pivot up to about 60 degrees out of plane 40.

Further, it is desirable for such containers to contain compositions that have relatively equal rheological or viscosity characteristics so that the compositions are dispensed in roughly a 1:1 ratio. Where additional means are provided for regulating the flow of a composition from the compartments, the use of orientation means and the rheological properties of the compositions are less critical.

The two compartment bottle 10 is preferably made in a single step using conventional shuttle or wheel blowing molding machines in such a way that it will accommodate a standard lined cap or closure. Of course, it is anticipated that more complex closure and/or dispensing devices such as trigger sprayers may also be used.

An extruded parison of the bottle material is clamped in place within mold 56. Mold 56 is closed around parison 54 and special blow pin 52 is inserted to simultaneously blow mold the two compartments. Mold 56 has an internal plate around which the blown parison forms the internal septum.

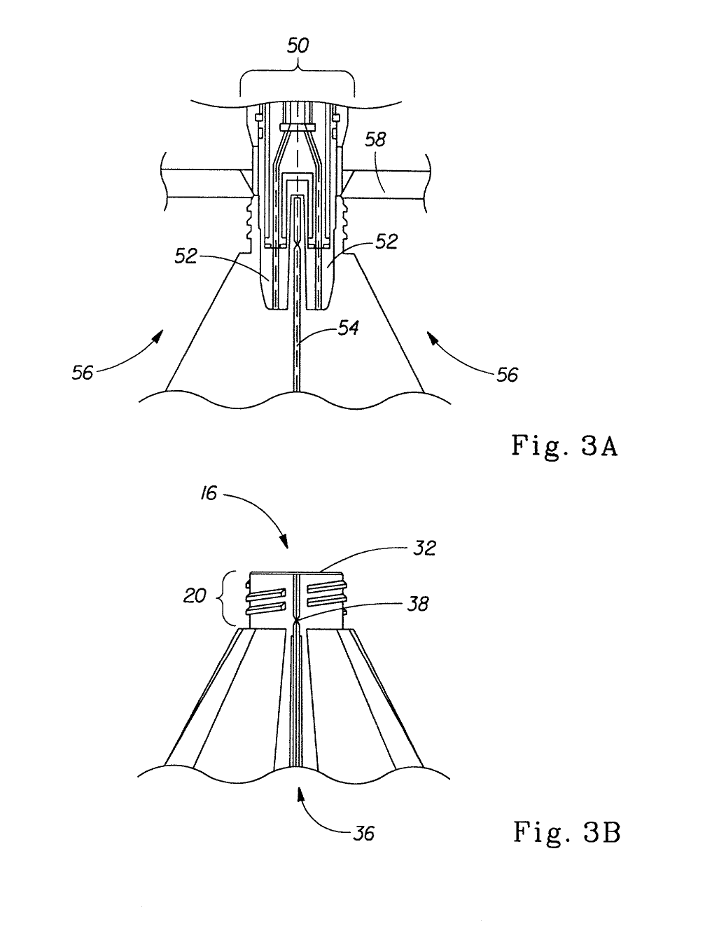

Flat surface 32 at the top of neck 20, is formed through the percussion of the blow pin on cutting ring 58. It is this flat surface 32 around the perimeter of neck opening 16 and across the top of the septum that insures a no leak bottle even when standard threaded closures are used. Also shown in more detail in FIG. 3b are channel 36 that extends through neck 20 and the narrowed region 38 that prevents the neck from collapsing under the excessive force.

Devices useful in conjunction with the Article: Dispensing Devices

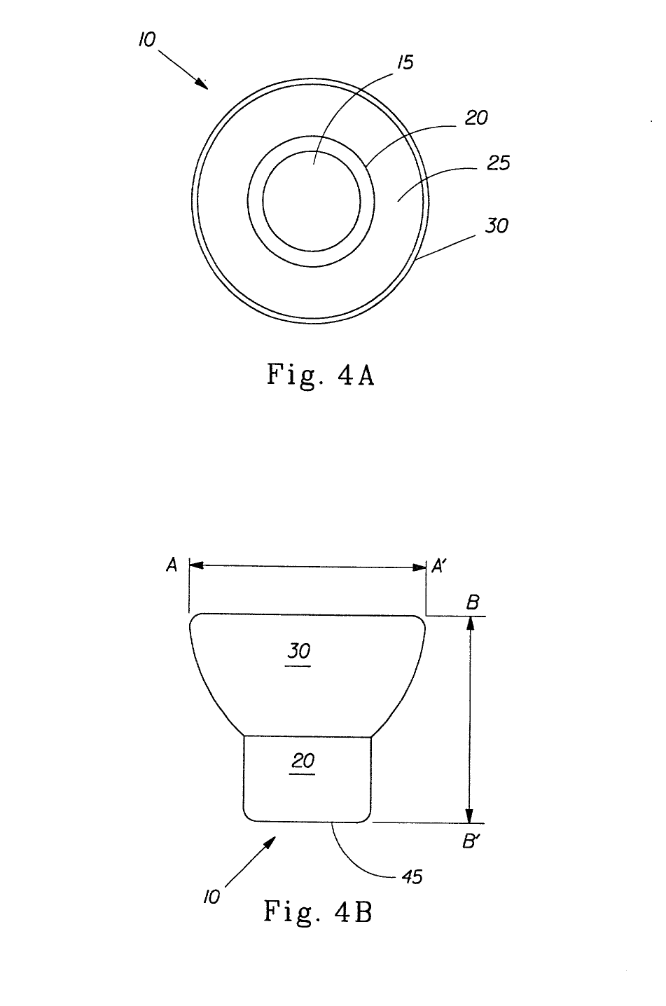

The container of the present invention is desirably used in conjunction with a dispensing device or article. For example, doses of a flowable detergent composition and a flowable bleaching composition can be simultaneously or sequentially (preferably simultaneously) dispensed from the container of the present inventive article, into a dispensing cup. The dispensing cup can be any of many types known in the art, including those types having the ability to act as laundry pretreatment dispensers or as a “dispensing ball” which can be placed in a washing machine. Suitable dispensing balls are disclosed in U.S. Pat. No. 5,267,671, assigned to The Procter & Gamble Company and in EP 0 368 680 B1 assigned to Unilever. More recently developed pretreatment-type dispensers include those known as the “rollerball” type sold by The Procter & Gamble Company under the trade name “Kick”. More preferably, a simple dispensing cup as illustrated in FIGS. 4a and 4b will be used in conjunction with the multi-compartment chambers of the present invention.

In addition, the dispensing cup can have features that will further improve the accuracy of dispensing compositions from a dual compartment container. Generally, features on the container that mate or nest with complementary features on the dispensing cup can be used as means to direct the user to hold the container in the proper orientation during dispensing. Obviously such orientation means can be used on any type of container, preferably multi-compartment container to provide consistent and accurate dispensing and are not restricted to the specific multi-compartment container of the present invention.

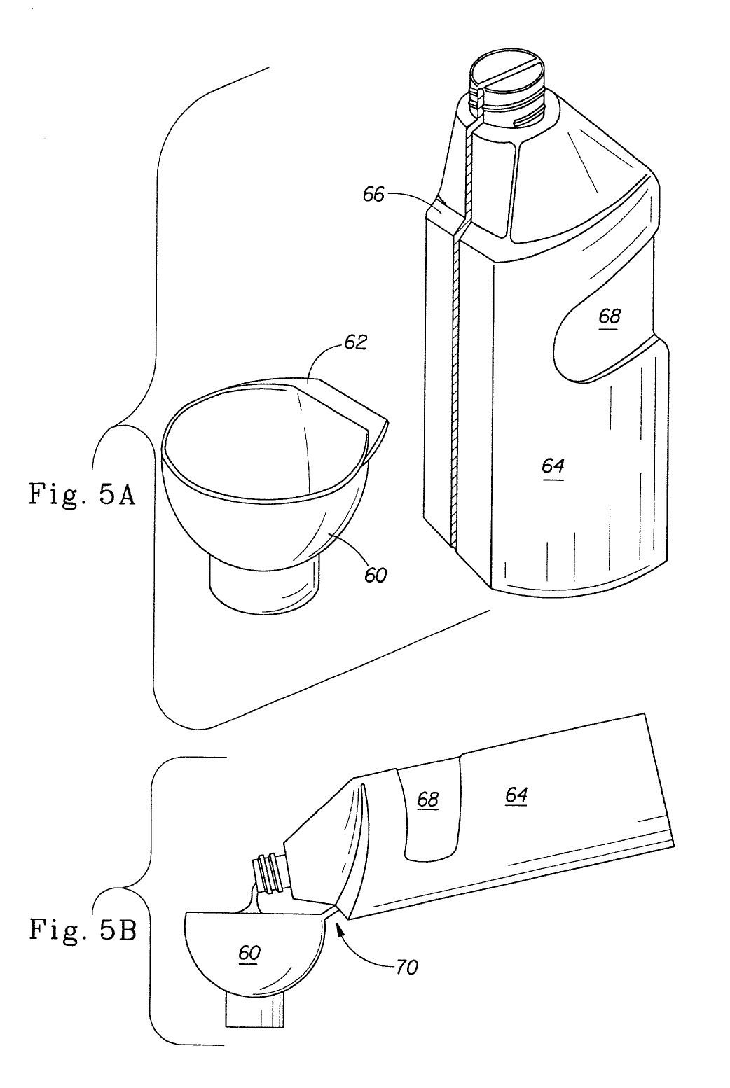

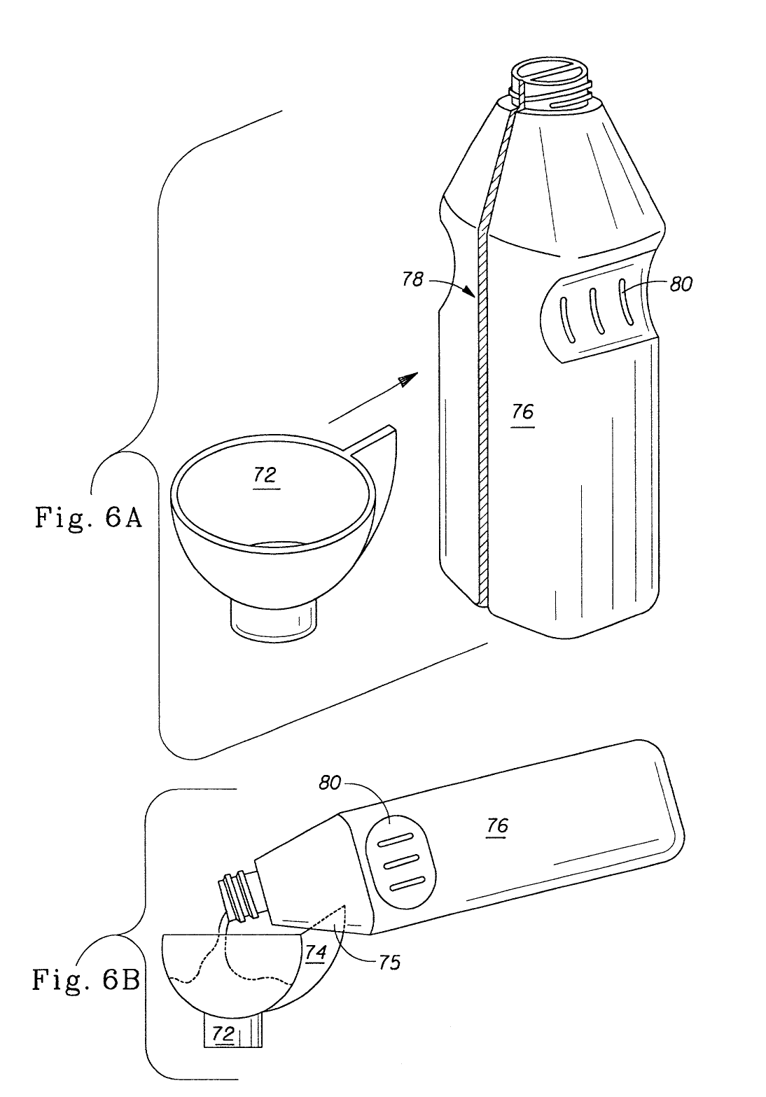

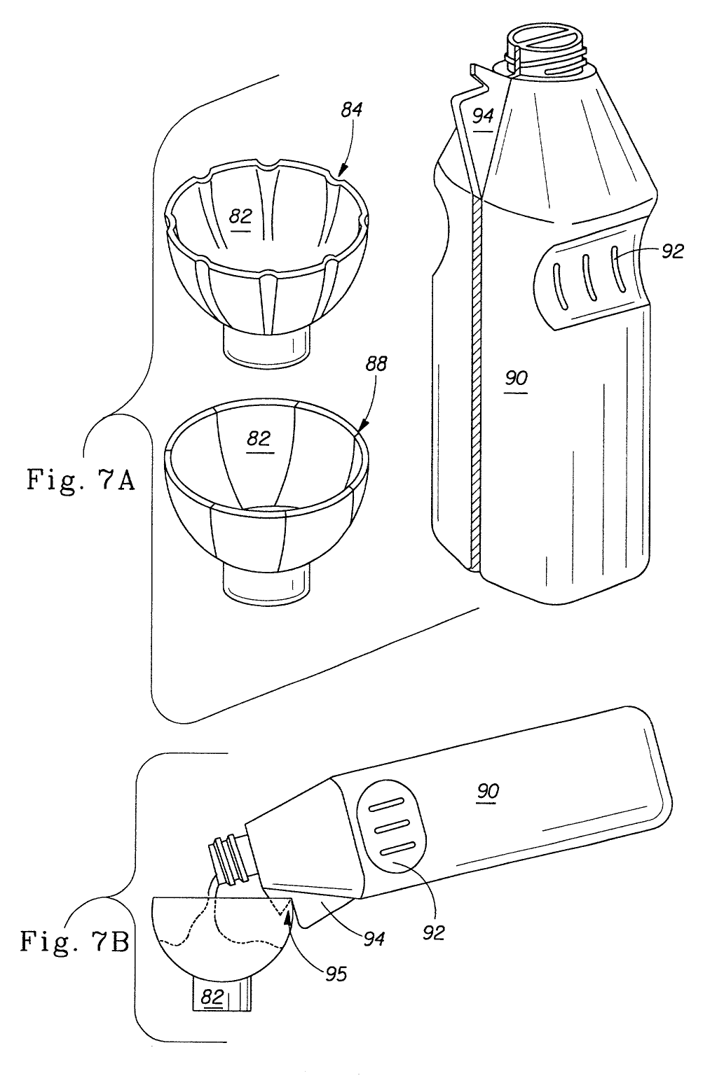

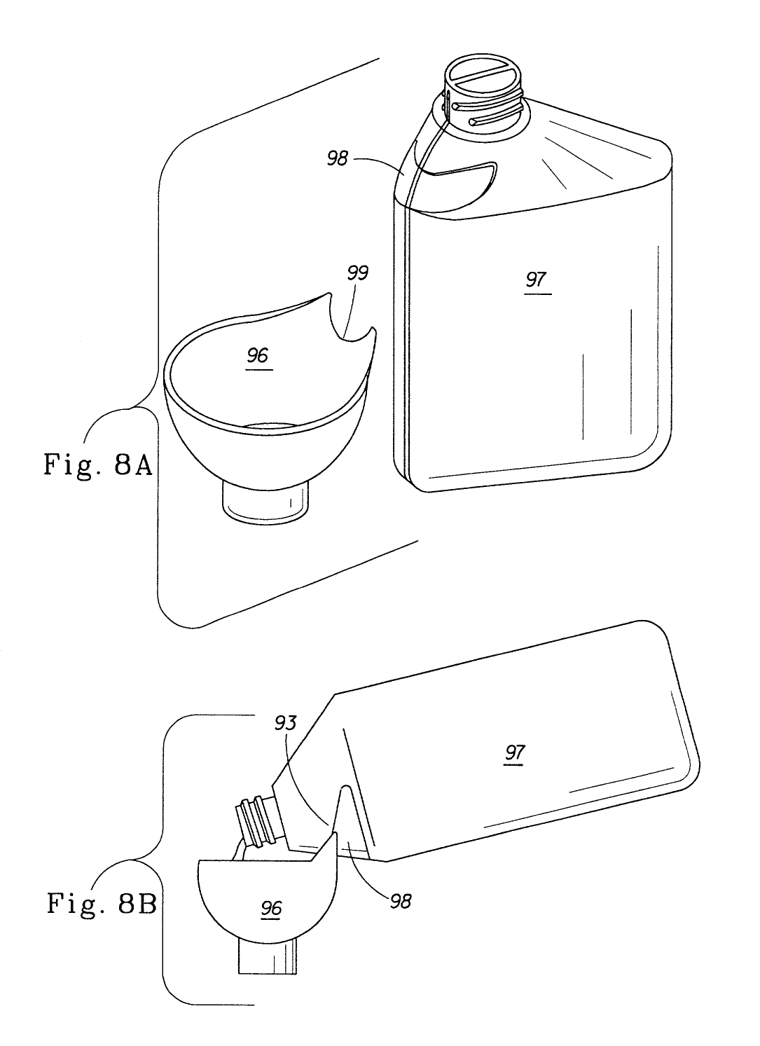

More specifically, FIGS. 5a through 8b illustrate a variety of means that can be used to direct the user to hold the container in the proper orientation during dispensing. These means are referred to herein and in the appended claims as “nesting means.” FIGS. 5a and 5b show container 64 that has recessed portions 68 for use as hand grips. Flat surface 66 on container 64 provides a straight surface for mating with straight edge 62 provided on dispenser 60. As shown in FIG. 5b, edge 62 is brought into contact with surface 66 and held there as container 64 is tilted to dispense the contents under the influence of gravity. In this orientation, the dual compartments of the container are held in a side by side orientation and the contents of the compartments flow from the container in 1:1 proportions, assuming similar rheological properties. Similarly, in FIGS. 6a and 6b, container 76 is provided with channel 78 for receiving fin 74 on dispenser 72. In FIGS. 7a and 7b, fin 94 is provided extending from the sidewall of container 90. Fin 94 engages with channels 84 or recessions 88 on dispensing cup 82. In FIGS. 8a and 8b, container 97 is provided with recessed portion 98 for mating with the edge 99 on dispensing cup 96.

Article

The present invention also provides an article of manufacture comprising a container such as is described above, a first flowable composition comprising less than 30% water, preferably less than 20% water, and no bleach, and a second flowable aqueous liquid bleach composition comprising less than about 30% bleach, preferably less than about 20% bleach, and more than about 30% water and preferably more than about 50% water. Suitable bleaches include PAP, TPCAP or other peracids, hydrogen peroxide, and mixtures thereof.

Example A

| Compartment 1 - First Flowable Composition | |
|---|---|
| Na C₁₂₋₁₃ alkyl sulfate 2.5 ethoxylated | 9.1 |
| Linear alkylbenzenesulfonic acid | 16.0 |
| C₁₃₋₁₅ alkyl 7 ethoxylated | 20.0 |
| C12-14 Fatty acid | 9.1 |
| Citric Acid | 1.0 |
| Propanediol | 8.5 |
| Cyclohexane dimethanol | 6.4 |
| Protease/amylase enzymes | 2.20 |
| Catalase | 0.24 |
| Boric acid | 2.00 |
| Tetraethylenepentamine 15 ethoxylate | 1.37 |
| Polyethyleneamine 600, 20 ethoxylate | 1.51 |
| perfume | 1.48 |
| monoethanolamine | 10 (to pH 8.0) |
| water | 10.90 |
| Compartment 2 - Second Flowable Composition | |
| Phtaloylamido peroxycaproic acid | 7.0 |
| Hydrogen peroxide | 0.8 |
| Xantham Gum | 0.4 |
| Hydroxyethane diphosphonic acid | 1.0 |
| Citric acid | 5.0 |
| Sodium hydroxide | About 1.5 (to pH 4) |
| Water | 84.30 |

Another example of an article of manufacture of the present invention is a container such as is described above, a first flowable composition comprising fabric care ingredients, a second flowable composition comprising cleaning ingredients, and in which the two liquids form a foam upon mixing together

Example B

| | |
|---|---|
| Compartment 1 - First Flowable Composition | |
| C45 alcohol 7-ethoxylate | 17 |
| C12-alkyl dimethylamine N-oxide | 2.5 |
| Hydroxyethane diphosphonic acid | 0.3 |
| Triethanolamine dicanoylester, quaternized, methylsulfate salt | 11 |
| Hydrogen peroxide | 2.7 |
| Cyclohexanedimethanol | 9.5 |
| Sulfuric acid | to pH 3.0 |
| Perfume/minors | 0.1 |
| Water | balance |
| Compartment 2 - Second Flowable Composition | |
| C45 alcohol 7-ethoxylate | 14 |
| C12-alkyl dimethylamine N-oxide | 3.5 |
| Citric acid | 3 |
| Polyethylenimine (MW 600), 20 ethoxylate | 1.2 |
| Ethoxylated tetraethylene pentamine | 0.6 |
| Catalase enzyme | 0.6 |
| Amylase enzyme | 0.12 |
| Protease enzyme | 0.03 |
| Cyclohexanedimethanol | 2.0 |
| Boric acid | 2.0 |
| Propandiol | 7.2 |
| Cationic silicone | 1.7 |
| Hydrogenated castor oil | 0.75 |
| Monoethanolamine | To pH 8.0 |
| Perfume/minors | 2.5 |
| Water | balance |

Kits

Preferred articles can be packaged in a kit, said kit additionally comprising a dispensing device, usage instructions, or combinations thereof.

Other Advantages, Other Embodiments and Ramifications

Having described the invention in detail with reference to preferred embodiments and the example, it will be clear to those skilled in the art that various changes and modifications may be made without departing from the scope of the invention and the invention is not to be considered limited to what is described in the specification. Most importantly, it will be recognized by those skilled in the art that the container of the present invention is not limited in terms of the flowable compositions that may contained and dispensed therefrom.

What is claimed is:

1. A one piece container for containing two or more different flowable compositions, the bottle comprising:
a base;
a neck having an opening for dispensing compositions;
a sidewall interconnecting the base and the neck and defining a chamber for the flowable compositions;
a septum downwardly extending from the opening that divides the chamber into two or more compartments; and
means for dispensing the compositions in substantially equal proportions when the compositions are dispensed from the bottle under the influence of gravity.

2. The container of claim 1, wherein the septum forms a pair of channels in the sidewall that run from the base through the neck, said channels being narrowed in the region where the neck connects with the sidewall or above this connection.

3. The container of claim 1, further comprising closure means for sealing the container, said closure means providing a seal at the opening that prevents leakage from the container and from one compartment to another.

4. The container of claim 1, wherein the means for dispensing the compositions in substantially equal proportions is a restrictor within the opening.

5. The container of claim 3, wherein restrictor controls the size of the opening.

6. The container of claim 3, wherein restrictor controls the shape of the opening.

7. The container of claim 1, wherein the septum extends downwardly from the opening to the base.

8. The container of claim 1, wherein the septum extends downwardly from the opening to the sidewall.

9. The container of claim 1, wherein the sidewall comprises front and rear walls that are a first length, a pair of intermediate sidewalls that are a second length that is shorter than the first length, and wherein the septum extends between the front and rear walls.

10. The container of claim 1, wherein the means for dispensing the compositions in substantially equal proportions comprises means for orienting the container such that the septum is maintained in substantially a vertical orientation during dispensing.

11. The container of claim 10, wherein the means for orienting the container are depressions in the sidewall to aid a consumer in holding the container during dispensing, said depressions having a long axis that is parallel to the septum.

12. The container of claim 10, wherein the means for orienting the container is a handle attached to the sidewall of the container in a plane that is parallel to the septum.

13. The container of claim 12, wherein the handle is pivotably attached to the sidewall.

14. The container of claim 13, wherein the handle can pivot from the plane up to about 60°.

15. The container of claim 10, wherein the means for orienting the container is a flip-top closure comprising a cap pivoting around a hinge axis which is perpendicular to the container septum plane.

16. The container of claim 1, wherein the sidewalls have a cross sectional shape having smooth rounded edges.

17. The container of claim 16, wherein the cross sectional shape is an oval, ellipse, or pyramid.

18. The container of claim 1, wherein the neck is located off-center.

19. The container of claim 1, wherein the neck is located adjacent the sidewall.

20. The container of claim 19, wherein the neck is located adjacent an apex between two non-parallel portions of the sidewall.

21. A kit for dispensing two or more compositions from a multi-compartment container, said kit comprising:
a multi-compartment container; and
a dispensing receptacle, wherein said container has means for nesting with the dispensing receptacle and/or wherein said dispensing receptacle has means for nesting with the container.

22. A method for making the container of claim 1, using a shuttle or wheel blower, the method comprising the steps of:
placing an extruded parison into a mold, when closed, said mold providing an internal wall dividing the mold into two or more compartments;
inserting a blow pin into the mold, said blow pin providing a flow of air to each compartment to expand said parison; and
actuating the blower to simultaneously form the base, sidewall, septum and neck portions of the container.

23. An article of manufacture comprising:
a container according to claim 1; and
a flowable laundry detergent composition, a flowable bleach composition or a flowable fabric care composition.
